(19) United States
(12) Patent Application Publication
(10) Pub. No.: US 2008/0031208 A1
(43) Pub. Date: Feb. 7, 2008

(54) Synchronization between wireless devices while saving power

(75) Inventors: Abhishek Abhishek, Woodinville, WA (US); Hui Shen, Issaquah, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/529,880

(22) Filed: Sep. 29, 2006

Related U.S. Application Data
(60) Provisional application No. 60/835,618, filed on Aug. 4, 2006.

(51) Int. Cl. H04Q 7/24

(52) U.S. Cl. 370/338

(57) ABSTRACT

A wireless device in an ad hoc network detects other wireless devices within radio range and establishes synchronization with the detected wireless devices. The wireless device operates in a power save mode and wakes up, or turns on, periodically or on demand to implement discoverability. A received probe request packet or beacon packet contains information which allows the receiving wireless device to discover the transmitting wireless device. The wireless device may operate in a discoverable mode or in an active discovery mode.

### CROSS-REFERENCE TO RELATED APPLICATIONS

This application claims the benefit of Provisional Application Ser. No. 60/835,618, filed Aug. 4, 2006, which is hereby incorporated by reference in its entirety.

This application is related to the following applications which are hereby incorporated by reference in their entirety.

1. Provisional Application Ser. No. 60/835,617, filed Aug. 4, 2006 and entitled “WIRELESS SUPPORT FOR PORTABLE MEDIA PLAYER DEVICES.”

2. Provisional Application Ser. No. 60/835,614, filed Aug. 4, 2006 and entitled “MANAGING ASSOCIATIONS IN AD HOC NETWORKS.”

### TECHNICAL FIELD

This invention relates to wireless networks and, more particularly, to ad hoc networks of wireless devices that are in proximity to each other.

### BACKGROUND

In a typical wireless network, one or more wireless devices are associated with a common wireless access point, which may be connected to a wired network. Communication between wireless devices is through the access point. Such operation is known as the infrastructure operating mode.

The IEEE 802.11 standard for wireless local area networks (LANs) provides for an ad hoc operating mode in which wireless devices communicate directly with each other without the use of a wireless access point or a wired network. However, in order to operate an ad hoc network of wireless devices, the wireless devices require a mechanism to discover other wireless network devices in proximity. Such a mechanism should have low power consumption, should create limited radio interference and should have high throughput.

### SUMMARY

The present invention provides methods for a wireless device in an ad hoc network to detect other wireless devices within radio range and to establish synchronization with the detected wireless devices. The wireless device operates in a power save mode and wakes up, or turns on, periodically or on demand to implement discoverability. A received probe request packet or beacon packet contains information which allows the receiving wireless device to discover the transmitting wireless device. The wireless device may operate in a discoverable mode or in an active discovery mode.

In a first embodiment, a wireless device in a discoverable mode does not send advertisement packets. Instead, the wireless device relies upon a broadcast probe request packet sent by a wireless device in an active discovery mode to achieve discoverability.

In a second embodiment, one wireless device in a discoverable mode transmits an advertisement packet to achieve synchronization with other wireless devices in proximity. An active discovery mode is activated on demand to transmit a broadcast probe request packet during a discovery window. A bootstrap operation permits a wireless device to activate the discoverable mode by listening for a beacon packet during a discovery window. If a beacon packet is received, the wireless device is synchronized according to information contained in the beacon packet. If a beacon packet is not received, the wireless device transmits a beacon packet.

According to a first aspect of the invention, a method to operate a wireless device in an ad hoc network is provided. The method comprises: operating the wireless device in a discoverable mode to enable discovery by neighbor wireless devices and to discover neighbor wireless devices passively; and operating the wireless device in an active discovery mode to actively discover neighbor wireless devices which are in the active discovery mode or the discoverable mode.

According to a second aspect of the invention, a wireless device is provided. The wireless device comprises: a computing device; a radio; and a wireless module logically connected to the computing device and to the radio. The wireless module comprises a processor programmed with instructions for: operating the wireless device in a discoverable mode to enable discovery by neighbor wireless devices and to discover neighbor wireless devices passively; and operating the wireless device in an active discovery mode to actively discover neighbor wireless devices which are in the active discovery mode or the discoverable mode.

According to a third aspect of the invention, a computer-readable medium programmed with instructions for executing a method to operate a wireless device in an ad hoc network is provided. The method comprises: operating the wireless device in a discoverable mode to enable discovery by neighbor wireless devices and to discover neighbor wireless devices passively; and operating the wireless device in an active discovery mode to actively discover neighbor wireless devices which are in the active discovery mode or the discoverable mode.

### BRIEF DESCRIPTION OF THE DRAWINGS

In the drawings:

FIG. 1 is a simplified block diagram of an ad hoc wireless network;

FIG. 2 is a simplified block diagram of a wireless device suitable for forming an ad hoc wireless network;

FIG. 3 is a flow chart that illustrates discoverable mode operation in the ad hoc network in accordance with a first method of synchronization;

FIG. 4 is a flow chart that illustrates active discovery in the ad hoc network in accordance with the first method of synchronization;

FIG. 5 is a timing diagram that illustrates an example of discovery in accordance with the first method of synchronization;

FIG. 6 is a flow chart that illustrates bootstrap operation in the ad hoc network in accordance with a second method of synchronization;

FIG. 7 is a timing diagram that illustrates an example of the bootstrap operation of FIG. 3;

FIG. 8 is a flow chart that illustrates discoverable mode operation in the ad hoc network in accordance with the second method of synchronization;

FIG. 9 is a flow chart that illustrates active discovery in the ad hoc network in accordance with the second method of synchronization; and

FIG. 10 is a timing diagram that illustrates examples of passive discovery and active discovery operations in accordance with the second method of synchronization.

### DETAILED DESCRIPTION

Embodiments of the invention provide mechanisms for a wireless device to bootstrap and synchronize with an ad hoc wireless network with low power consumption. Further embodiments of the invention provide mechanisms to discover neighbor wireless devices with low power consumption.

These mechanisms involve software in the wireless devices. The mechanisms can also be implemented in hardware and/or firmware of a wireless device. This allows wireless devices having these mechanisms to communicate and to form ad hoc wireless networks. The communication between wireless devices in the ad hoc network has no effect on other wireless devices that do not support these mechanisms.

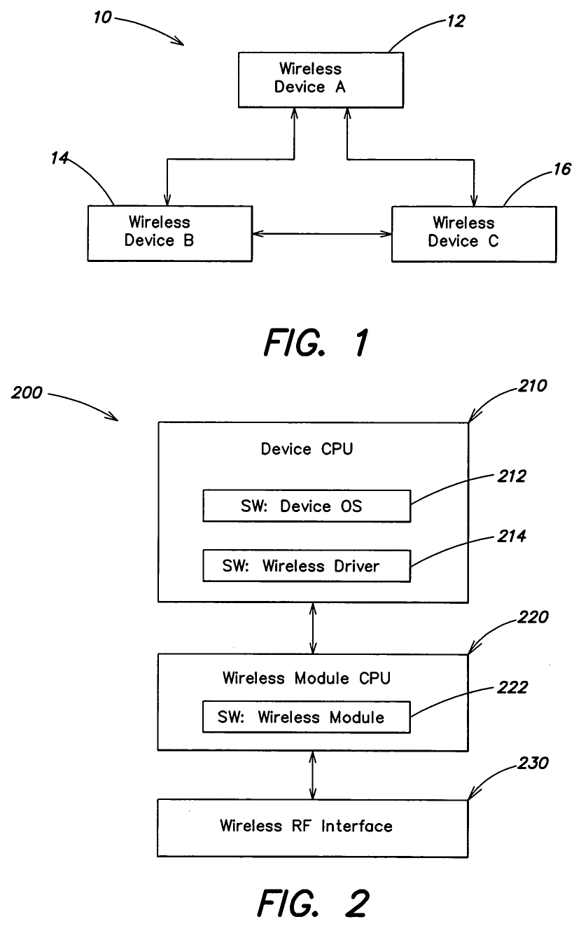

An example of a wireless ad hoc network 10 is shown in FIG. 1. Wireless devices 12, 14 and 16 communicate with each other by a wireless links. The wireless devices communicate using the mechanisms described below. It is assumed that each wireless device is within radio range of at least one other wireless device in the ad hoc network. It will be understood that all wireless devices in the ad hoc network do not need to be within radio range. For example, wireless devices 14 and 16 may be able to communicate directly with wireless device 12 but may not be able to communicate directly with each other. By way of example only, wireless devices 12, 14 and 16 may be laptop computers, mobile phones, mobile data devices, portable media player devices, home stereos, wireless speakers, or combinations of such devices which utilize a compatible protocol as described below.

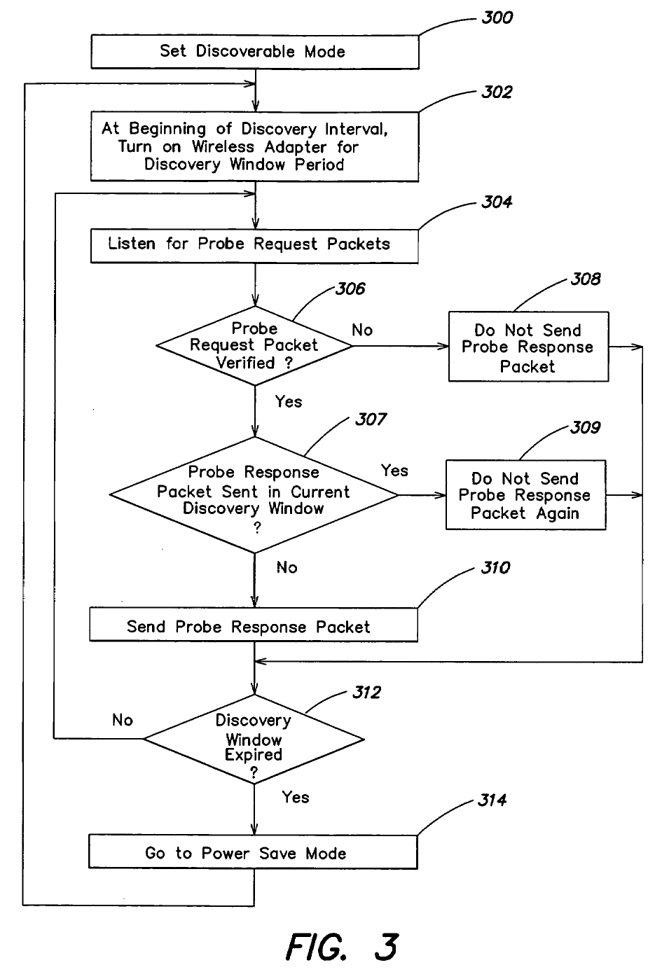

A simplified block diagram of a wireless device 200 including components involved in communication in an ad hoc network is shown in FIG. 2. Wireless device 200 may correspond to wireless devices 12, 14 and 16 shown in FIG. 1. An upper layer device CPU 210 interfaces with peripheral components present in the wireless device, such as a display, a keypad or a keyboard, a pointing device, a storage unit such as a disk unit or a flash memory and any other peripheral components of the device. Device CPU 210 includes a device operating system 212 and a wireless driver 214. The wireless driver 214 communicates with a second layer wireless module CPU 220 containing wireless module software 222. The wireless module software 222 interfaces with a lower layer wireless RF interface 230 which communicates with a radio that transmits and receives RF signals via an antenna.

The wireless device 200 may represent a variety of different devices that may be hand-held and mobile or stationary. Examples of wireless devices include, but are not limited to, laptop computers, desktop computers, mobile data devices, mobile phones, stereo systems, and wireless speakers.

The operations of each wireless device in discovering and synchronizing with other wireless devices are described below. Operation is described in connection with the IEEE 802.11 standard. However, the present invention is not limited to the 802.11 standard and can be utilized in connection with other wireless protocols, such as Ultra Wide Band and WiNet. It will be understood that the operations described below are embodiments only and are not limiting as to the scope of the invention.

### Discovery Modes

When a wireless device has its wireless operation turned on, it can be set in one of two discovery modes: discoverable mode or active discovery mode.

### Discoverable Mode

A wireless device is set to be in the discoverable mode if the user expects neighbor wireless devices to be in proximity and wants to be discovered by other wireless devices as well as to discover neighbor wireless device passively. In this mode, the wireless device is able to detect neighbor devices which are actively discovering, and to also announce its existence.

### Active Discovery Mode

A wireless device is set to be in the active discovery mode on user demand. In this mode, the wireless device actively detects neighbor wireless devices which are in active or discoverable mode, and also announces its own existence to those devices.

### Parameters

Discovery Interval: A period of time that a wireless device periodically resumes from power save mode and discovers neighbor wireless devices in the discoverable mode. This time period includes the discovery window.
   For example: 2000 ms.
Discovery Window: A period of time that a wireless device remains with power on and performs passive discovery.
   For example: 100 ms.
Active Probe Interval: A time slot in which a wireless device divides a probe period into multiple time slots. The probe interval should be smaller than the discovery window.
   For example: 80 ms.
Active Probe Period: A period of time that a wireless device performs active discovery operation on demand. This time period includes multiple Probe Periods. A probe period should be larger than the discovery interval and preferably a multiple of discovery intervals.
   For example: 2100 ms.

All devices may have the same values pre-configured for the above parameters.

### Method 1

Wireless devices wake up periodically to maintain discoverability, and they do not send advertisement packets, such as beacon packets in IEEE 802.11 networks, into the wireless medium. The wireless devices utilize only probe request and response packets to achieve discoverability.

### Discoverable Mode

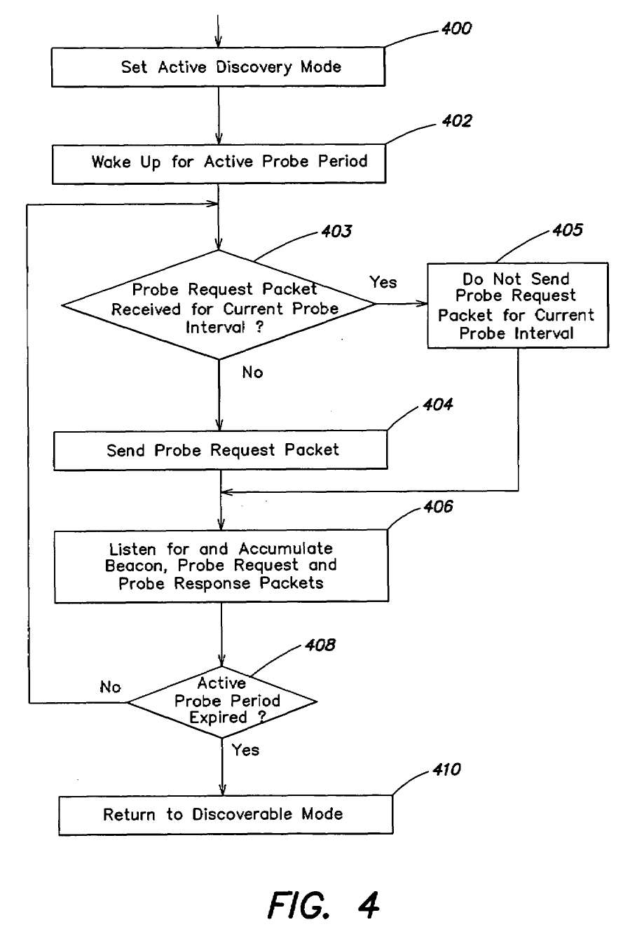

A flow chart of Method 1 discoverable mode operations is shown in FIG. 3.
1) A wireless device switches to the discoverable mode on demand. The device does the following:
   Set to be in discoverable mode, step 300.
   This request may have the following parameters or use pre-configured default values:
      Discovery Interval, and
      Discovery Window.

When a wireless device wants to be discovered by other devices, it stays in the discoverable mode. When a device is in the discoverable mode, it can stop sending out any periodic beacon packets.

The values of these parameters can be pre-defined as default values or can be set by the application which sets the device into the discoverable mode.
1) The wireless device stays in the power save mode in most of the discovery interval. It does so by turning off its wireless radio. At the beginning of each Discovery Interval, the wireless device wakes up from the power save mode for a period of time equal to the Discovery Window, step 302. During this window, the device parks at a discovery channel which is commonly used by all the devices for discovery purposes.
2) The wireless device listens for probe request packets, step 304. When the device receives a probe request packet, optionally, the wireless module verifies that it wants to respond to the probe packet.

If a wireless device wants to verify a probe request packet, it can do so in different ways, provided the method is mutually agreed and understood by the devices involved in the discovery process. For example:

The probe request packet may be an IEEE 802.11 probe request packet. In addition, the packet can contain special information to specify the intention of discovering a particular type of device and settings. The packet may have the following information:
Packet type: probe request packet
Receiver's address: broadcast address (FF-FF-FF-FF-FF-FF)
SSID: (broadcast SSID: 0-length IE)
BSSID: broadcast address (FF-FF-FF-FF-FF-FF)
BSS type: ad hoc
Other information (e.g., timestamp)
Special information:
Operation type—discovery request
   Other optional device/configuration specific information
3) If the probe request packet is verified, step 306, the wireless device checks to determine if it has sent a probe response packet earlier in the current discovery window, step 307. If not, the probe request is honored and a probe response packet is sent, step 310. Otherwise, the wireless device can choose to not send a probe response packet, step 309, to reduce wireless channel usage and interference. The wireless device replies to the probe request packet by sending a probe response packet, step 310, provided the packet format and content are mutually agreed and understood by the devices involved in the discovery process. For example:

The probe response packet may be an IEEE 802.11 probe response packet. Optionally, the packet can contain special information to specify the intention of responding to a discovery for a particular type of device and settings. The packet may have the following information:

Packet type: probe response packet

Receiver's address: unicast address (to the sender of the probe request), or broadcast address (if sender wants to be discovered by all devices in proximity)
SSID: current SSID (if available)
BSSID: current BSSID (if available)
BSS type: ad hoc
Other information (e.g., timestamp)
Special information:
   Operation type—discovery response
   Other optional device/configuration specific information

Otherwise, the device decides not to honor the probe request packet and does not send a probe response packet, step 308. However, the probe request packet can be used to discover a neighbor wireless device.
4) When the discovery window expires for the current discovery interval, step 312, the device goes to the power save mode, step 314, and does not receive or send any packets.
5) In the discoverable mode, the wireless device repeats the operations from 1) to 4) (steps 302 to 314).

### Active Discovery Mode

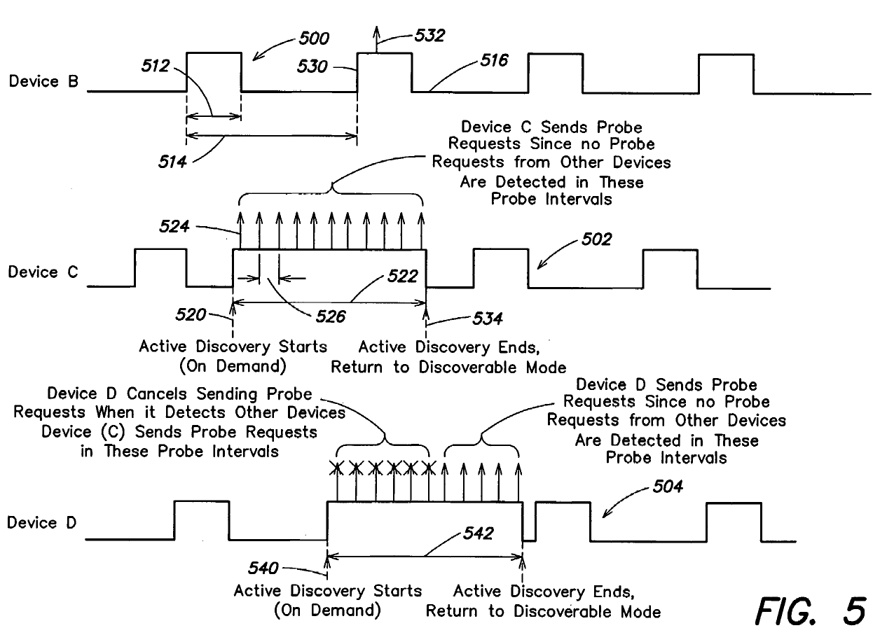

A flow chart of Method 1 active discovery mode operations is shown in FIG. 4.

When a wireless device wants to actively discover other devices, the wireless device does the following:
1) Issue a scan request call (set active discovery mode, step 400):
   Scan (to actively discover other devices)

The scan request call may have the following parameters or use pre-configured default values:
Scan type: active scan
Special IE (information element) information: (optional)
2) When receiving the scan request call, the wireless module does the following:
   The device wakes up if it is in the power save mode for an active probe period, step 402, a period of time no less than discovery interval, for example 2100 ms.

The wireless device does the following for each active probe interval, a period of time which is no longer than the discovery window, for example 80 ms. If the wireless device does not receive any probe request packets from other wireless devices in the current probe interval, step 403, it then sends out a probe request packet in the discovery channel, step 404. Otherwise, the wireless device can choose not to send a probe request packet for the current probe interval, step 405, to reduce channel usage and interference.

The probe request packet has a packet format and content that are mutually agreed and understood by the devices involved in the discovery process. For example:

The probe request packet may be an 802.11 probe request packet. Optionally, the packet can contain special information to specify the intention of requesting discovery for a particular type of device and settings. The packet can have the following information:
Packet type: probe request packet
Receiver's address: broadcast address (FF-FF-FF-FF-FF-FF)
SSID: (broadcast SSID: 0-length IE)
BSSID: broadcast address (FF-FF-FF-FF-FF-FF)
BSS type: ad hoc
Other information (e.g., timestamp)
Special IE:
Operation type—discovery request
Other optional local information
3) After sending out each probe request packet, the wireless device remains awake and listens to the probe response packets from other devices, step 406. It can do so by parking on each channel to listen to probe response packets for a period of time.

The probe response packet has a packet format and content that are mutually agreed and understood by the devices involved in the discovery process. For example:

The probe response packet may be an IEEE 802.11 probe response packet. Optionally, the packet can contain special information to specify the intention of responding a discovery for a particular type of device and settings. The packet may have the following information:
Packet type: probe response packet
Receiver's address: unicast address (to the sender of the probe request), or broadcast address (if sender wants to be discovered by all devices in proximity)
SSID: current SSID (if available)
BSSID: current BSSID (if available)
BSS type: ad hoc
Other information (e.g., timestamp)
Special IE:
   Operation type—discovery response
   Other optional local information
4) When the active probe period expires, step 408, the wireless device returns to its initial state, step 410.

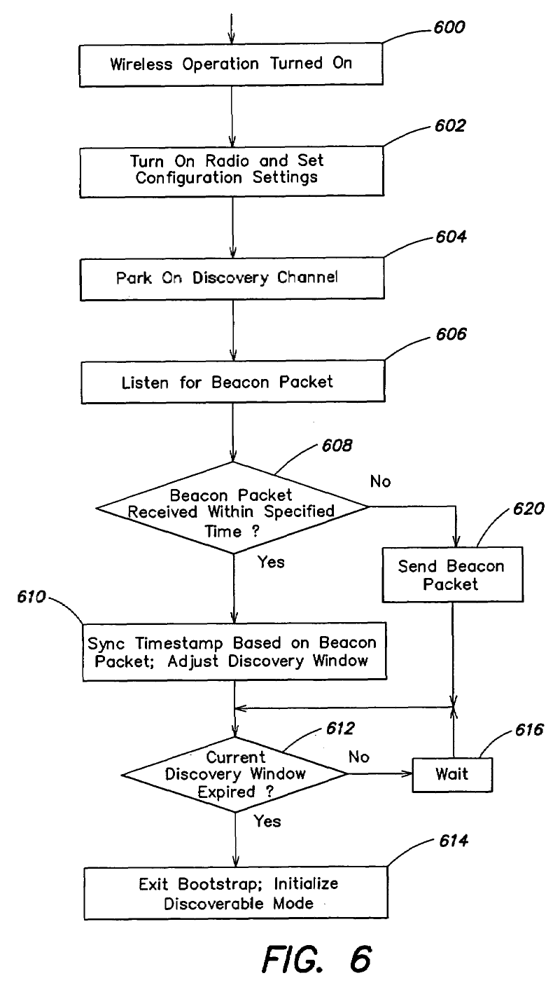

A timing diagram that illustrates an example of active discovery in accordance with the first method of synchronization is shown in FIG. 5. A waveform 500 represents a device B, such as wireless device 14 shown in FIG. 1, in a discoverable mode. A waveform 502 represents a device C, such as wireless device 16 in FIG. 1, in an active discovery mode. A waveform 504 represents a device D in an active discovery mode. Device B turns on during a discovery window 512 which is repeated each discovery period 514, or interval. Between discovery windows, device B is in a power save mode 516. In the example of FIG. 5 the discovery window 512 is 100 msec and the discovery period 514 is 2000 msec.

Device C is initially in discoverable mode and starts active discovery at time 520 in response to a user request. For example, device C turns on for an active probe period 522 which is greater than the discovery period 514 utilized in the discoverable mode. In the example of FIG. 5, the active probe period is 2100 msec. During the active probe period, device C sends multiple probe requests 524 separated by an active probe interval 526. The active probe interval 526 is shorter than the discovery window 512 and is selected to ensure that at least one of the probe requests is received during the discovery window of other wireless devices in proximity to device C. Device B receives a probe request from device C during discovery window 530 and sends a probe response at time 532. The probe response from device B and probe responses from other devices in proximity are accumulated and saved by device C. At time 534 the active probe period expires, and device C returns to the discoverable mode. In the discoverable mode, device C turns on during the discovery window of each discovery period and is in power save mode for the remainder of each discovery period.

Device D starts active discovery at time 540 for active probe period 542 in response to a user request. As shown in FIG. 5, active probe period 522 of device C and active probe period 542 of device D partially overlap in time. As further shown in FIG. 5, device D cancels sending probe requests when it detects device C sending probe requests in probe intervals which overlap with the active probe period 522 of device C. Device D sends probe requests during a part of active probe period 542 which does not overlap active probe period 522, since no probe requests from other devices are detected in those probe intervals. Device C sends probe requests during active probe period 522, since no probe requests from other devices are detected in those probe intervals. In the discovery method of FIG. 5, the discovery windows of devices B, C and D are not synchronized.

### Method 2

Wireless devices wake up periodically to maintain discoverability. This method allows one wireless device in a group of wireless devices in proximity to transmit advertisement packets during the wake up window to achieve synchronization.

### Bootstrap Mode

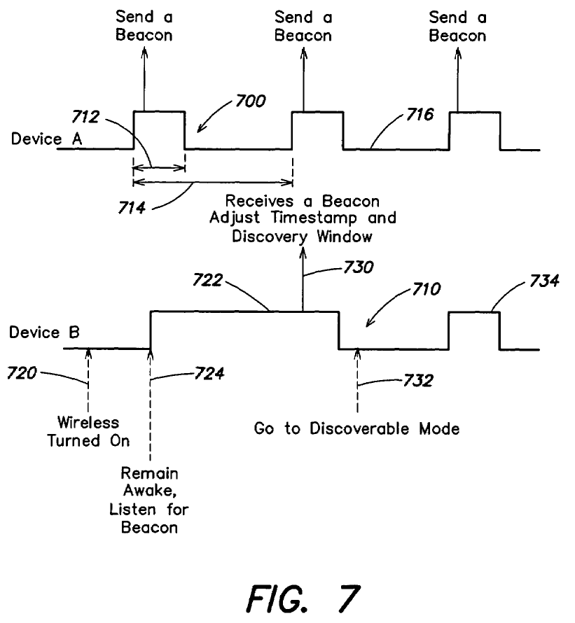

A flow chart of Method 2 bootstrap mode operations is shown in FIG. 6.

When a wireless device first boots up and switches to the bootstrap mode, step 600, the wireless device turns on its wireless radio, step 602, and follows the bootstrap operations described below.
1) Park on the discovery channel and stay awake, step 604.
2) Listen for beacon packets, step 606.

A beacon packet may be an 802.11 beacon packet with special information as follows:
Receiver address: broadcast address (FF-FF-FF-FF-FF-FF)
SSID: (do not contain SSID IE)
BSSID: unicast address of the portable media player device sending the beacon packet
BSS type: ad hoc
Special information:
Operation type—beacon
Other optional local information
3) If a beacon packet is received, step 608, then the device does the following:
   a) Use the beacon packet to sync its internal timestamp, step 610.
   b) Adjust the discovery window to be the same as that of the sender of the beacon packets, step 610.
   c) Wait until the current discovery window expires, steps 612, 616, and then exit the bootstrap operation, step 614.
4) Otherwise, the device does not receive a beacon packet within certain amount of time (configurable parameter and default to be 3 Discovery Intervals (6000 ms) defined below), step 608. In this case, the device does the following:
   a) Send out a beacon packet, step 620.
   b) Wait until the current discovery window expires, steps 612, 616, and then exit the bootstrap operation, step 614.

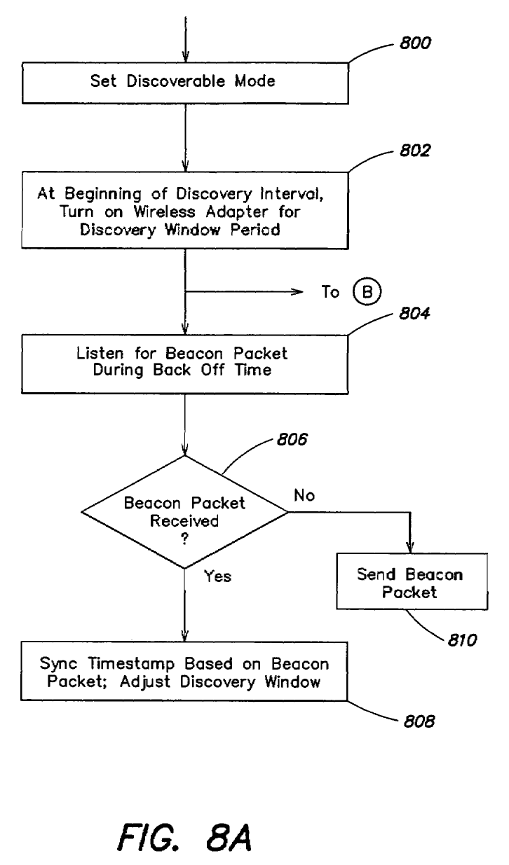

A timing diagram that illustrates bootstrap operation. According to the second method of synchronization as shown in FIG. 7, a waveform 700 represents a device A, such as wireless device 12 shown in FIG. 1, in a passive discovery mode and sending beacon packets a waveform 710 represents a device B, such as wireless device 14 in FIG. 1, in a bootstrap mode. Device A turns on during a discovery window 712 which is repeated each discovery period 714. Between discovery windows, device A is in a power save mode 716. During each discovery window, device A sends a beacon packet and listens for probe responses. In the example of FIG. 7, the discovery window 712 is 100 msec and the discovery period 714 is 2000 msec.

Device B has its wireless operation turned on at time 720 and listens for a beacon packet during a listening period 722 beginning at time 724. The listening period 722 is at least as great as the discovery period 714 and preferably is about three times the discovery period. At time 730, device B receives a beacon packet and adjusts its internal timestamp and discovery window to synchronize with device A. Then, device B switches to the discoverable mode at time 732. Subsequently, device B listens for probe requests during discovery windows 734 which are synchronized to the discovery windows of device A.

### Discoverable Mode

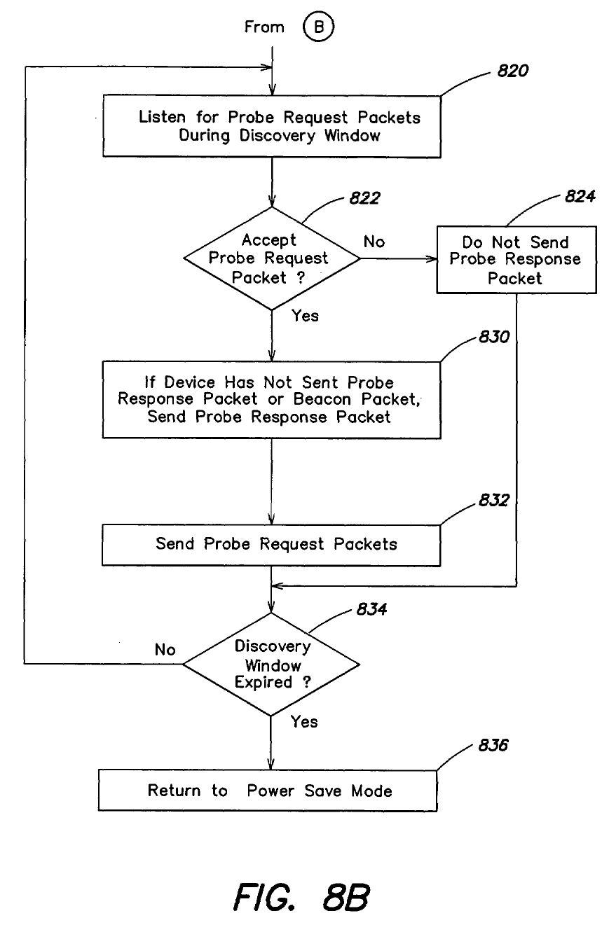

A flow chart of Method 2 discoverable mode operations is shown in FIG. 8.
1) A wireless device switches to the discoverable mode on demand. The device does the following:

Set to be in discoverable mode, step 800.

This request may have the following parameters or use pre-configured default values:
Discovery Interval, and
Discovery Window.
2) At the beginning of each Discovery Interval, the wireless device wakes up from power save mode and turns on its wireless adapter for a period of time equal to the Discovery Window, step 802. During this window, the device parks at a discovery channel which is commonly used by all the devices for discovery purposes.
3) The wireless module waits a random back-off time (to be fine tuned with specific wireless devices) and listens for a beacon packet, step 804.
   If a beacon packet is received, step 806, then the wireless module uses this packet to adjust its internal timestamp, step 808.
   Otherwise, a beacon packet is not received in the back-off time, step 806. In this case, the wireless module sends out a beacon packet, step 810.
4) During the Discovery Window, the wireless module also listens for probe request packets, step 820.
   The wireless device may verify the received packet to be a probe request packet by matching the following information:
      SSID: (do not contain SSID IE)
      BSSID: broadcast address (FF-FF-FF-FF-FF-FF)
      BSS type: ad hoc
      Special information:
         Operation type—discovery
         Other optional local information
   If the packet is not a probe request packet, step 822, a probe response packet is not sent, step 824.
   Otherwise, the packet is a probe request packet.
   If the wireless module has not sent any probe response packet or beacon packet in the current discovery window, then a probe response packet is sent out, step 830.
   The probe response packet may be an 802.11 probe response packet with special information as follows:
      Receiver address: broadcast address (FF-FF-FF-FF-FF-FF)
      SSID: (do not contain SSID IE)
      BSSID: unicast address of the wireless device sending the probe response packet
      BSS type: ad hoc
      Special information:
         Operation type—probe response
         Other optional local information
   Otherwise, the wireless module has already sent a beacon packet or has responded with a probe response packet. The wireless module does not send out any more broadcast probe response packets.
   In addition, the wireless module accumulates all received probe response packets from unique wireless devices, and saves them in its neighbor wireless device information list, step 832. It can return this list to the wireless service, which in turn reports to the application upon query.
5) When the Discovery Window expires, step 834, the wireless device returns to the power save mode, step 836, until the next discovery Interval starts.
6) Steps 2) to 5) are repeated.

### Active Discovery Mode

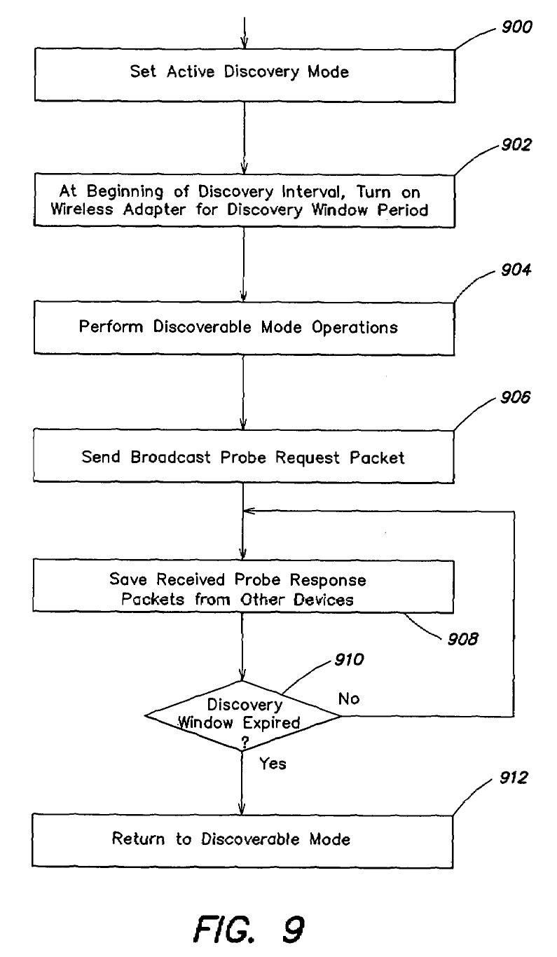

A flow chart of Method 2 active discovery mode operation is shown in FIG. 9.
1) A wireless device switches to the active discovery mode, step 900, on demand. The caller does the following:
   Issue an active discovery request
      Scan (to actively discover other devices)
2) The wireless module waits until the next discovery window starts. Then the wireless device wakes up from the power save mode and turns on its wireless adapter for a period of time equal to the Discovery Window, step 902.
3) In the discovery window, the wireless module continues performing the operations described in the discoverable mode, step 904, including:
   a. Listen for and send out beacon packet,
   b. Listen for probe request packets and accumulate neighbor device information, and
   c. Respond with a probe response packet when needed.
4) In addition, the wireless module sends out a probe request packet, step 906.
   The probe request packet may be an 802.11 broadcast probe request packet with special information as follows:
      Receiver address: broadcast address (FF-FF-FF-FF-FF-FF)
      SSID: (do not contain SSID IE)
      BSSID: broadcast address (FF-FF-FF-FF-FF-FF)
      BSS type: ad hoc
      Special information:
         Operation type—probe request
         Other optional local information
   The wireless module accumulates all received beacon, probe request and probe response packets from unique wireless devices, and saves them in its neighbor wireless device information list, step 908. It can return this list to the wireless service, which in turn reports to the application upon query.
5) When the current discovery window expires, step 910, the device returns to the initial state (discoverable mode), step 912.

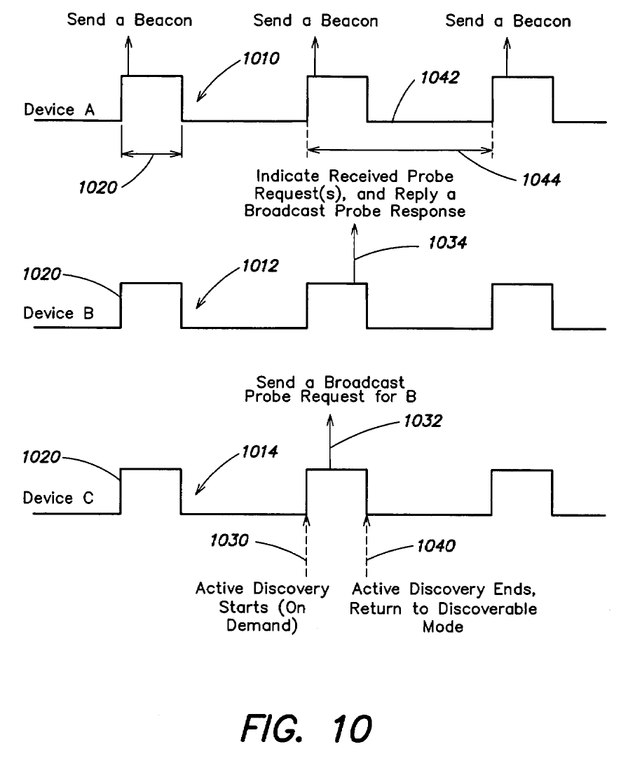

A timing diagram showing wireless devices performing passive discovery and active discovery as shown in FIG. 10. A waveform 1010 represents device A, such as device 12 shown in FIG. 1, in the discoverable mode and sending beacon packets. A waveform 1012 represents a device B, such as wireless device 14 shown in FIG. 1, in the discoverable mode and not sending beacon packets. A waveform 1014 represents a device C, such as wireless device 16 shown in FIG. 1, in active discovery mode. Device A sends a beacon packet during each discovery window 1020 and listens for probe responses during the discovery windows. Device B listens for probe requests during each discovery window 1020.

Device C switches to the active discovery mode at time 1030 and sends a broadcast probe request at time 1032. Device B sends a probe response at time 1034 in response to the probe request sent by device C. Device A does not respond to the broadcast probe request from device C, because it is sending beacon packets which are received by device C. At the end of the discovery window at time 1040, active discovery ends and device C returns to the passive discovery mode. As shown in FIG. 10, each of devices A, B and C listens for probe requests during synchronized discovery windows 1020 and is in power save mode 1042 for the remainder of the discovery period 1044. In the example of FIG. 10, the discovery window 1020 is 100 msec and the discovery period 1044 is 2000 msec.

### Cache and Utilize Discovery Results

The wireless device accumulates received beacon, probe request and probe response packets sent from other wireless devices, and saves the device information in its neighbor device information list. It can return this list as the discovery result to the upper layer service or application if requested.

The wireless device can use the information from the neighbor device information list to establish synchronization with a discovered wireless device.

The wireless device may have an aging function to expire stale wireless device information entries from its neighbor device information list.

### Special Information Element

The special information contained in the beacon, probe request and probe response packets can be represented in the format of an information element (IE). The IE is a type-length-value object that is used to carry variable length information. The wireless device can optionally rely on the special information element to contain information for managing discovery and synchronization.

For example, the special IE can either use a unique IE ID, or a customer IE ID (e.g., value 221 defined by IEEE 802.11 standard) with a unique OUI and OUI type combination to identify itself.

| IE ID | Length | OUI | OUI Type | Other information |
|---|---|---|---|---|
| (1 byte) | (1 byte) | (3 byte) | (1 byte) | (0–249 bytes) |
| 221 | 8 . . . 253 | (e.g. 00-50-F2 | (unique | Other information |
| | | for Microsoft) | value with | for discovery |
| | | | the same | |
| | | | OUI) | |

The special information element can contain the following operation type for managing discovery and synchronization:

Operation type
Discovery request
Discovery response
Beacon

The above description and the accompanying drawings provide examples of values for various parameters, such as timing parameters. It will be understood that such values are given by way of example only and are not in any way limiting as to the scope of the invention.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method to operate a wireless device in an ad hoc network, comprising:
operating the wireless device in a discoverable mode to enable discovery by neighbor wireless devices and to discover neighbor wireless devices passively; and
operating the wireless device in an active discovery mode to actively discover neighbor wireless devices which are in the active discovery mode or the discoverable mode.

2. A method as defined in claim 1, further comprising:
operating the wireless device in the discoverable mode during a discovery window of a periodic discovery interval; and
operating the wireless device in a power save mode during an inactive portion of the periodic discovery interval.

3. A method as defined in claim 1, wherein operating the wireless device in the discoverable mode comprises:
turning on a radio of the wireless device for a discovery window of a periodic discovery interval;
listening for probe request packets during the discovery window;
if a received probe request packet is verified and no probe response packet has been sent in a current discovery window, sending a probe response packet containing identifying information;
otherwise, not sending a probe response packet; and
operating the wireless device in a power save mode during an inactive portion of the periodic discovery interval.

4. A method as defined in claim 1, wherein operating the wireless device in the active discovery mode comprises:
turning on a radio of the wireless device for an active discovery period, in response to activation of the active discovery mode, the active discovery period being at least as long as a periodic discovery interval utilized by discoverable wireless devices;
sending a probe request packet for each active probe interval of the active discovery period if no other wireless device has sent a probe request packet earlier in a current probe interval, the active probe interval being shorter than a discovery window of the discoverable wireless devices;
listening for received probe response packets received during the active discovery period;
saving information contained in each of the received probe response packets; and
returning to the discoverable mode when the active discovery period expires.

5. A method as defined in claim 1, further comprising:
turning on a radio of the wireless device in response to activation of wireless operation;
listening for a beacon packet for a specified time;
if a beacon packet is received in the specified time, adjusting timing of a discovery window in accordance with parameters received in the beacon packet; and
if a beacon packet is not received in the specified time, sending a beacon packet.

6. A method as defined in claim 1, wherein operating the wireless device in the discoverable mode comprises:
turning on a radio of the wireless device during a discovery window of a periodic discovery interval, in response to activation of the discoverable mode;
listening for a beacon packet for a random back-off time;
if a beacon packet is received within the random back-off time, adjusting timing of the discovery window in accordance with parameters in the received beacon packet;
if a beacon packet is not received within the random back-off time, sending a beacon packet;
listening for a probe request packet during the discovery window;
saving information relating to received probe request packets;
sending a probe response packet if the wireless device has not sent a probe response packet or a beacon packet in the current discovery window; and
operating the wireless device in a power save mode during an inactive portion of the periodic discovery interval.

7. A method as defined in claim 1, wherein operating the wireless device in the active discovery mode comprises:
turning on a radio of the wireless device during a discovery window of a periodic discovery interval, in response to activation of the active discovery mode;
sending a broadcast request packet during the discovery window;
saving information contained in response packets sent by other wireless devices in response to the broadcast request packet; and
operating the wireless device in a power save mode during an inactive portion of the periodic discovery interval.

8. A wireless device comprising:
a computing device;
a radio; and
a wireless module logically connected to the computing device and to the radio, the wireless module comprising a processor programmed with instructions for:
operating the wireless device in a discoverable mode to enable discovery by neighbor wireless devices and to discover neighbor wireless devices passively; and
operating the wireless device in an active discovery mode to actively discover neighbor wireless devices which are in the active discovery mode or the discoverable mode.

9. A wireless device as defined in claim 8, wherein the instructions further include instructions for:
operating the wireless device in the discoverable mode during a discovery window of a periodic discovery interval; and
operating the wireless device in a power save mode during an inactive portion of the periodic discovery interval.

10. A wireless device as defined in claim 8, wherein the instructions for operating the wireless device in the discoverable mode include instructions for:
turning on the radio for a discovery window of a periodic discovery interval;
listening for probe request packets during the discovery window;
if a received probe request packet is verified and no probe response packet has been sent in a current discovery window, sending a probe response packet containing identifying information;
otherwise, not sending a probe response packet; and
operating the wireless device in a power save mode during an inactive portion of the periodic discovery interval.

11. A wireless device as defined in claim 8, wherein the instructions for operating the wireless device in the active discovery mode include instructions for:
turning on the radio for an active discovery period, in response to activation of the active discovery mode, the active discovery period being at least as long as a periodic discovery interval utilized by discoverable wireless devices;
sending a probe request packet for each active probe interval of the active discovery period if no other wireless device has sent a probe request packet earlier in a current probe interval, the active probe interval being shorter than a discovery window of the discoverable wireless devices;
listening for received probe response packets received during the active discovery period;
saving information contained in each of the received probe response packets; and
returning to the discoverable mode when the active discovery period expires.

12. A wireless device as defined in claim 8, wherein the instructions further include instructions for:
turning on the radio in response to activation of wireless operation;
listening for a beacon packet for a specified time;
if a beacon packet is received in the specified time, adjusting timing of a discovery window in accordance with parameters received in the beacon packet; and
if a beacon packet is not received in the specified time, sending a beacon packet.

13. A wireless device as defined in claim 8, wherein the instructions for operating the wireless device in the discoverable mode include instructions for:
turning on the radio during a discovery window of a periodic discovery interval, in response to activation of the discoverable mode;
listening for a beacon packet for a random back-off time;
if a beacon packet is received within the random back-off time, adjusting timing of the discovery window in accordance with parameters in the received beacon packet;
if a beacon packet is not received within the random back-off time, sending a beacon packet;
listening for a probe request packet during the discovery window;
saving information relating to received probe request packets;
sending a probe response packet if the wireless device has not sent a probe response packet or a beacon packet in the current discovery window; and
operating the wireless device in a power save mode during an inactive portion of the periodic discovery interval.

14. A wireless device as defined in claim 8, wherein the instructions for operating the wireless device in the active discovery mode include instructions for:
turning on the radio during a discovery window of a periodic discovery interval, in response to activation of the active discovery mode;
sending a broadcast request packet during the discovery window;
saving information contained in response packets sent by other wireless devices in response to the broadcast request packet; and
operating the wireless device in a power save mode during an inactive portion of the periodic discovery interval.

15. A computer-readable medium programmed with instructions for executing a method to operate a wireless device in an ad hoc network, comprising:
operating the wireless device in a discoverable mode to enable discovery by neighbor wireless devices and to discover neighbor wireless devices passively; and
operating the wireless device in an active discovery mode to actively discover neighbor wireless devices which are in the active discovery mode or the discoverable mode.

16. A computer-readable medium as defined in claim 15, wherein operating the wireless device in the discoverable mode comprises:
turning on a radio of the wireless device for a discovery window of a periodic discovery interval;
listening for probe request packets during the discovery window;
if a received probe request packet is verified and no probe response packet has been sent in a current discovery window, sending a probe response packet containing identifying information;
otherwise, not sending a probe response packet; and
operating the wireless device in a power save mode during an inactive portion of the periodic discovery interval.

17. A computer-readable medium as defined in claim 15, wherein operating the wireless device in the active discovery mode comprises:
turning on a radio of the wireless device for an active discovery period, in response to activation of the active discovery mode, the active discovery period being at least as long as a periodic discovery interval utilized by discoverable wireless devices;
sending a probe request packet for each active probe interval of the active discovery period if no other wireless device has sent a probe request packet earlier in a current probe interval, the active probe interval being shorter than a discovery window of the discoverable wireless devices;
listening for received probe response packets received during the active discovery period;
saving information contained in each of the received probe response packets; and
returning to the discoverable mode when the active discovery period expires.

18. A computer-readable medium as defined in claim 15, wherein the method further comprises:
turning on a radio of the wireless device in response to activation of wireless operation;
listening for a beacon packet for a specified time;
if a beacon packet is received in the specified time, adjusting timing of a discovery window in accordance with parameters received in the beacon packet; and
if a beacon packet is not received in the specified time, sending a beacon packet.

19. A computer-readable medium as defined in claim 15, wherein operating the wireless device in the discoverable mode comprises:
turning on a radio of the wireless device during a discovery window of a periodic discovery interval, in response to activation of the discoverable mode;
listening for a beacon packet for a random back-off time;
if a beacon packet is received within the random back-off time, adjusting timing of the discovery window in accordance with parameters in the received beacon packet;
if a beacon packet is not received within the random back-off time, sending a beacon packet;
listening for a probe request packet during the discovery window;
saving information relating to received probe request packets;
sending a probe response packet if the wireless device has not sent a probe response packet or a beacon packet in the current discovery window; and
operating the wireless device in a power save mode during an inactive portion of the periodic discovery interval.

20. A computer-readable medium as defined in claim 15, wherein operating the wireless device in the active discovery mode comprises:
turning on a radio of the wireless device during a discovery window of a periodic discovery interval, in response to activation of the active discovery mode;
sending a broadcast request packet during the discovery window;
saving information contained in response packets sent by other wireless devices in response to the broadcast request packet; and
operating the wireless device in a power save mode during an inactive portion of the periodic discovery interval.
